(19) United States
(12) Patent Application Publication
(10) Pub. No.: US 2026/0316561 A1
(43) Pub. Date: Oct. 15, 2026

(54) ADAPTIVE USER INTERFACE FOR A VEHICLE

(71) Applicant: GM Global Technology Operations LLC, Detroit, MI (US)

(72) Inventors: Eshan Dixit, Farmington Hills, MI (US); Mark R. Claywell, Birmingham, MI (US); Azeem Sarwar, Rochester Hills, MI (US); Mihir Gupte, Royal Oak, MI (US); Bryan K. Pryor, Clarkston, MI (US)

(21) Appl. No.: 19/176,489

(22) Filed: Apr. 11, 2025

(51) Int. Cl. B60K 35/21; B60K 35/10; B60K 35/28

(52) U.S. Cl. CPC B60K 35/21; B60K 35/10; B60K 35/28

(57) ABSTRACT

A method for providing information to an occupant of a vehicle may include determining one or more inputs using one or more vehicle sensors. The method further may include determining a layout of each of a plurality of user-interface (UI) elements of an infotainment system based at least in part on the one or more inputs. The method further may include providing information to the occupant of the vehicle by displaying the plurality of UI elements on the infotainment system based at least in part on the layout of each of the plurality of UI elements.

### INTRODUCTION

The present disclosure relates to systems and methods for providing information to an occupant of a vehicle, and more particularly, for vehicle infotainment system user-interface functionality and design.

To facilitate user interaction with infotainment systems in vehicle applications, various user interface technologies may be utilized. Vehicle infotainment systems may include display screens, touch-sensitive controls, physical buttons, voice recognition modules, and/or the like to enable interaction with navigation, media playback, climate control, communication systems, and other vehicle functions. In some examples, user interfaces may incorporate configurable layouts or menu structures that adjust based on user preferences. Additionally, infotainment system interfaces may integrate with external devices through wireless communication protocols, allowing users to access mobile applications, cloud services, or real-time traffic and weather updates. Some vehicle infotainment interfaces also provide multimodal interaction capabilities, such as combining voice commands with haptic feedback or gesture recognition to enhance usability while minimizing driver distraction.

While systems and methods for vehicle infotainment user interfaces achieve their intended purpose, there is a need for new and improved systems and methods for vehicle infotainment system user interface functionality and design for providing information to occupants of vehicles.

### SUMMARY

According to several aspects, a method for providing information to an occupant of a vehicle is provided. The method may include determining one or more inputs using one or more vehicle sensors. The method further may include determining a layout of each of a plurality of user-interface (UI) elements of an infotainment system based at least in part on the one or more inputs. The method further may include providing information to the occupant of the vehicle by displaying the plurality of UI elements on the infotainment system based at least in part on the layout of each of the plurality of UI elements.

In another aspect of the present disclosure, determining the one or more inputs further may include determining the one or more inputs. The one or more inputs include measurements of vehicle operating conditions. The vehicle operating conditions include one or more of a speed of the vehicle, an acceleration of the vehicle, and a vibration of the vehicle.

In another aspect of the present disclosure, determining the one or more inputs further may include determining the one or more inputs. The one or more inputs include information about external environmental conditions.

In another aspect of the present disclosure, determining the one or more inputs further may include determining the one or more inputs. The information about external environmental conditions includes one or more of: a weather condition in an environment surrounding the vehicle and a traffic congestion condition in the environment surrounding the vehicle.

In another aspect of the present disclosure, determining the layout of each of the plurality of UI elements further may include determining an importance score of each of the plurality of UI elements based at least in part on the one or more inputs and one or more UI element characteristics of each of the plurality of UI elements. Determining the layout of each of the plurality of UI elements further may include determining the layout of each of the plurality of UI elements based at least in part on the importance score of each of the plurality of UI elements.

In another aspect of the present disclosure, determining the importance score of each of the plurality of UI elements further may include determining the importance score of each of the plurality of UI elements based at least in part on the one or more UI element characteristics of each of the plurality of UI elements. The one or more UI element characteristics includes a UI element purpose of each of the plurality of UI elements.

In another aspect of the present disclosure, determining the importance score of each of the plurality of UI elements further may include determining the importance score of each of the plurality of UI elements based at least in part on the one or more UI element characteristics of each of the plurality of UI elements. The UI element purpose of each of the plurality of UI elements includes information about an inherent importance of each of the plurality of UI elements.

In another aspect of the present disclosure, determining the importance score of each of the plurality of UI elements further may include determining the importance score of each of the plurality of UI elements based at least in part on the one or more inputs. The one or more inputs includes a speed of the vehicle. The importance score of each of the plurality of UI elements is positively correlated with the speed of the vehicle.

In another aspect of the present disclosure, determining the layout of each of the plurality of UI elements further may include determining the layout of each of the plurality of UI elements based at least in part on the importance score of each of the plurality of UI elements. The layout includes at least a size of each of the plurality of UI elements. The size of each of the plurality of UI elements is positively correlated with the importance score of each of the plurality of UI elements.

In another aspect of the present disclosure, determining the layout of each of the plurality of UI elements further may include determining the layout of each of the plurality of UI elements based at least in part on the importance score of each of the plurality of UI elements. The layout includes at least a location of each of the plurality of UI elements on the infotainment system. A distance between the location of each of the plurality of UI elements and an edge of the infotainment system is negatively correlated with the importance score of each of the plurality of UI elements.

According to several aspects, a system for providing information to an occupant of a vehicle is provided. The system may include one or more vehicle sensors, an infotainment system, and a controller in electrical communication with the one or more vehicle sensors and the infotainment system. The controller is programmed to determine one or more inputs using the one or more vehicle sensors. The controller is further programmed to determine a layout of each of a plurality of user-interface (UI) elements of the infotainment system based at least in part on an importance score of each of the plurality of UI elements. The importance score is determined based at least in part on the one or more inputs and one or more UI element characteristics of each of the plurality of UI elements. The controller is further programmed to provide information to the occupant of the vehicle by displaying the plurality of UI elements on the infotainment system based at least in part on the layout of each of the plurality of UI elements.

In another aspect of the present disclosure, the one or more inputs include measurements of vehicle operating conditions. The vehicle operating conditions include one or more of: a traction control system activation status of the vehicle and a time-averaged frequency of accelerator pedal actuations.

In another aspect of the present disclosure, the one or more inputs include information about external environmental conditions. The information about external environmental conditions includes one or more of: a visibility in an environment surrounding the vehicle and a distance between the vehicle and a nearest remote vehicle.

In another aspect of the present disclosure, to determine the importance score of each of the plurality of UI elements, the controller is further programmed to determine the importance score of each of the plurality of UI elements based at least in part on the one or more UI element characteristics of each of the plurality of UI elements. The one or more UI element characteristics includes a frequency of use of each of the plurality of UI elements.

In another aspect of the present disclosure, to determine the importance score of each of the plurality of UI elements, the controller is further programmed to determine the importance score of each of the plurality of UI elements based at least in part on a traffic congestion condition. The importance score of each of the plurality of UI elements is positively correlated with a traffic density in the environment surrounding the vehicle.

In another aspect of the present disclosure, to determine the layout of each of the plurality of UI elements, the controller is further programmed to determine the layout of each of the plurality of UI elements based at least in part on the importance score of each of the plurality of UI elements. The layout includes at least a size of each of the plurality of UI elements. The size of each of the plurality of UI elements is positively correlated with the importance score of each of the plurality of UI elements.

In another aspect of the present disclosure, to determine the layout of each of the plurality of UI elements, the controller is further programmed to determine the layout of each of the plurality of UI elements based at least in part on the importance score of each of the plurality of UI elements. The layout includes at least a location of each of the plurality of UI elements on the infotainment system. A distance between the location of each of the plurality of UI elements and an edge of the infotainment system is negatively correlated with the importance score of each of the plurality of UI elements.

According to several aspects, a method for providing information to an occupant of a vehicle is provided. The method may include determining one or more inputs using one or more vehicle sensors. The one or more inputs include one or more of: a speed of the vehicle, an acceleration of the vehicle, a vibration of the vehicle, a weather condition in an environment surrounding the vehicle, and a traffic congestion condition in the environment surrounding the vehicle. The method further may include determining a layout of each of a plurality of user-interface (UI) elements of an infotainment system based at least in part on an importance score of each of the plurality of UI elements. The importance score is determined based at least in part on the one or more inputs. The importance score of each of the plurality of UI elements is positively correlated with the speed of the vehicle. The method further may include providing information to the occupant of the vehicle by displaying the plurality of UI elements on the infotainment system based at least in part on the layout of each of the plurality of UI elements.

In another aspect of the present disclosure, determining the layout of each of the plurality of UI elements further may include determining the layout of each of the plurality of UI elements based at least in part on the importance score of each of the plurality of UI elements. The layout includes at least a size of each of the plurality of UI elements. The size of each of the plurality of UI elements is positively correlated with the importance score of each of the plurality of UI elements.

In another aspect of the present disclosure, determining the layout of each of the plurality of UI elements further may include determining the layout of each of the plurality of UI elements based at least in part on the importance score of each of the plurality of UI elements. The layout includes at least a location of each of the plurality of UI elements on the infotainment system. A distance between the location of each of the plurality of UI elements and an edge of the infotainment system nearest to the occupant is negatively correlated with the importance score of each of the plurality of UI elements.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a system for providing information to an occupant of a vehicle, according to an exemplary embodiment;

FIG. 2 is a schematic diagram of an interior of the vehicle, according to an exemplary embodiment;

FIG. 3 is a schematic diagram of a first exemplary user-interface for an infotainment system, according to an exemplary embodiment;

FIG. 4 is a flowchart of a method for providing information to an occupant of a vehicle, according to an exemplary embodiment; and

FIG. 5 is a schematic diagram of a second exemplary user-interface for an infotainment system, according to an exemplary embodiment.

### DETAILED DESCRIPTION

The following description is merely exemplary in nature and is not intended to limit the present disclosure, application, or uses.

In aspects of the present disclosure, it is advantageous to adapt/adjust the layout and/or functionality of a user-interface of a vehicle infotainment system based on vehicle and/or environmental conditions. Accordingly, the present disclosure provides a new and improved system and method for providing information to an occupant of a vehicle which accounts for current conditions when generating user-interfaces.

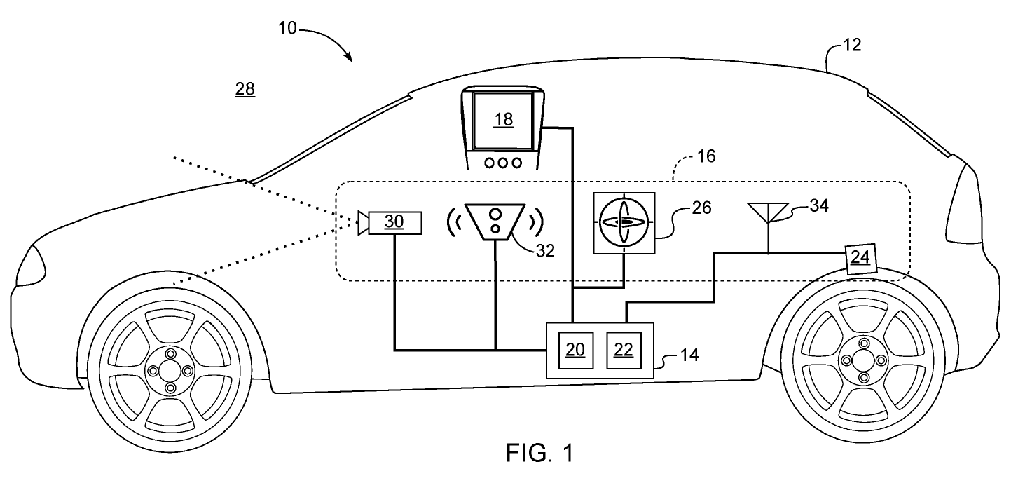

Referring to FIG. 1, a system for providing information to an occupant of a vehicle is illustrated and generally indicated by reference number 10. The system 10 is shown with an exemplary vehicle 12. While a passenger vehicle is illustrated, it should be appreciated that the vehicle 12 may be any type of vehicle without departing from the scope of the present disclosure. The system 10 generally includes a controller 14, one or more vehicle sensors 16, and an infotainment system 18.

The controller 14 is used to implement a method 100 for providing information to an occupant of a vehicle, as will be described below. The controller 14 includes at least one processor 20 and a non-transitory computer readable storage device or media 22. The processor 20 may be a custom made or commercially available processor, a central processing unit (CPU), a graphics processing unit (GPU), an auxiliary processor among several processors associated with the controller 14, a semiconductor-based microprocessor (in the form of a microchip or chip set), a macroprocessor, a combination thereof, or generally a device for executing instructions.

The computer readable storage device or media 22 may include volatile and nonvolatile storage in read-only memory (ROM), random-access memory (RAM), and keep-alive memory (KAM), for example. KAM is a persistent or non-volatile memory that may be used to store various operating variables while the processor 20 is powered down. The computer-readable storage device or media 22 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 14 to control various systems of the vehicle 12.

The controller 14 may also include multiple controllers which are in electrical communication with each other. The controller 14 may be inter-connected with additional systems and/or controllers of the vehicle 12, allowing the controller 14 to access data such as, for example, speed, acceleration, braking, and steering angle of the vehicle 12.

The controller 14 is in electrical communication with the one or more vehicle sensors 16 and the infotainment system 18. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 14 are within the scope of the present disclosure. It should further be understood that, in the scope of the present disclosure, electrical communication also includes power and/or energy transfer between electrical devices (e.g., using conducting wires and/or wireless power transmission techniques).

The one or more vehicle sensors 16 are used to acquire information relevant to the vehicle 12. In an exemplary embodiment, the one or more vehicle sensors 16 includes sensors to determine performance data and/or operating conditions about the vehicle 12. In a non-limiting example, the one or more vehicle sensors 16 includes at least one of a motor speed sensor, a motor torque sensor, an electric drive motor voltage and/or current sensor, an accelerator pedal position sensor, a brake position sensor, a coolant temperature sensor, a cooling fan speed sensor, and a transmission oil temperature sensor.

In an exemplary embodiment, the one or more vehicle sensors 16 further includes a vehicle speed sensor 24. The vehicle speed sensor 24 is used to measure a speed of the vehicle 12. In an exemplary embodiment, the vehicle speed sensor 24 includes a toothed ferromagnetic ring or disk (also known as a reluctor or tone ring) mechanically linked to a wheel of the vehicle 12 such that the toothed ferromagnetic ring rotates at a same speed as the wheel of the vehicle 12. The vehicle speed sensor 24 further includes a sensor (e.g., a coil of wire) which is affixed near the toothed ferromagnetic ring and is stationary relative to the toothed ferromagnetic ring such that the sensor experiences an induced alternating voltage due to the changing magnetic field caused by the rotation of the toothed ferromagnetic ring.

In a non-limiting example, the induced alternating voltage is sinusoidal, and a magnitude and/or frequency of the induced alternating voltage is proportional to a rotational speed of the toothed ferromagnetic ring and thus the vehicle speed. In an exemplary embodiment, the induced alternating voltage is transmitted directly to the controller 14 for further processing, for example, using an analog-to-digital converter of the controller 14. In another exemplary embodiment, the vehicle speed sensor 24 further includes signal conditioning circuitry which further processes the induced alternating voltage before transmission to the controller 14 (e.g., amplifying the induced alternating voltage, digitizing the induced alternating voltage, encoding the vehicle speed value into a communication protocol, and/or the like).

It should be understood that various additional devices and methods for determining vehicle speed, such as, for example, global navigation satellite systems (e.g., GPS), sensors measuring other drivetrain components (e.g., transmission speed sensor, electric motor speed sensor, and/or the like), and/or the like are within the scope of the present disclosure. The vehicle speed sensor 24 is in electrical communication with the controller 14 as discussed above.

In an exemplary embodiment, the one or more vehicle sensors 16 further includes an inertial measurement unit (IMU) 26. The IMU 26 is used to determine an orientation, velocity, and gravitational forces acting upon the vehicle 12. In an exemplary embodiment, the IMU 26 includes several sensors, including accelerometers, gyroscopes, and/or magnetometers. In a non-limiting example, the IMU 26 includes three-axis accelerometers and three-axis gyroscopes, which are integrated into a single unit. The accelerometers measure linear acceleration along each axis, while the gyroscopes measure angular velocity about each axis. The IMU 26 processes data from the sensors to calculate the current orientation, speed, heading, yaw rate (i.e., rate of change of heading), and acceleration of the vehicle 12 in three-dimensional space. The IMU 26 is in electrical communication with the controller 14, as discussed above.

In another exemplary embodiment, the one or more vehicle sensors 16 further includes sensors to determine information about external environmental conditions in an environment 28 surrounding the vehicle 12. In a non-limiting example, the one or more vehicle sensors 16 further includes at least one of an ambient air temperature sensor, a barometric pressure sensor, and/or a global navigation satellite system (GNSS).

In an exemplary embodiment, the one or more vehicle sensors 16 further includes one or more perception sensors capable of perceiving objects and/or measuring distances in the environment 28 surrounding the vehicle 12 such as a camera system 30 and/or a LiDAR sensor 32. It should be understood that various additional types of perception sensors, such as, for example, ultrasonic ranging sensors, radar sensors, and/or time-of-flight sensors are within the scope of the present disclosure.

The camera system 30 is a perception sensor used to capture images and/or videos of the environment 28 surrounding the vehicle 12. In an exemplary embodiment, the camera system 30 includes a photo and/or video camera which is positioned to view the environment 28 surrounding the vehicle 12. In a non-limiting example, the camera system 30 includes a camera affixed inside of the vehicle 12, for example, in a headliner of the vehicle 12, having a view through the windscreen. In another non-limiting example, the camera system 30 includes a camera affixed outside of the vehicle 12, for example, on a roof of the vehicle 12, having a view of the environment 28 in front of the vehicle 12.

In another exemplary embodiment, the camera system 30 is a surround view camera system including a plurality of cameras (also known as satellite cameras) arranged to provide a view of the environment 28 adjacent to all sides of the vehicle 12. In a non-limiting example, the camera system 30 includes a front-facing camera (mounted, for example, in a front grille of the vehicle 12), a rear-facing camera (mounted, for example, on a rear tailgate of the vehicle 12), and two side-facing cameras (mounted, for example, under each of two side-view mirrors of the vehicle 12). In another non-limiting example, the camera system 30 further includes an additional rear-view camera mounted near a center high mounted stop lamp of the vehicle 12.

It should be understood that camera systems having additional cameras and/or additional mounting locations are within the scope of the present disclosure. It should further be understood that cameras having various sensor types including, for example, charge-coupled device (CCD) sensors, complementary metal oxide semiconductor (CMOS) sensors, and/or high dynamic range (HDR) sensors are within the scope of the present disclosure. Furthermore, cameras having various lens types including, for example, wide-angle lenses and/or narrow-angle lenses are also within the scope of the present disclosure.

The LiDAR sensor 32 is utilized for remote sensing and environmental mapping by emitting laser pulses and measuring the time it takes for the laser pulses to return to the LiDAR sensor 32 after hitting objects. In an exemplary embodiment, the LiDAR sensor 32 includes a LiDAR laser source, a LiDAR scanner or mirror, a LiDAR photodetector, and a LiDAR time-of-flight measurement system. In a non-limiting example, the LiDAR laser source emits laser pulses that travel to the target area, and the LiDAR scanner directs these pulses in different directions. The emitted laser pulses interact with objects in the environment and their reflections are captured by the LiDAR photodetector. The LiDAR time-of-flight measurement system calculates the distance to the objects based on the time between emission of the laser pulses by the LiDAR laser source and reception of the reflected laser pulses by the LiDAR photodetector. The LiDAR sensor 32 is in electrical communication with the controller 14, as discussed above.

In another exemplary embodiment, the one or more vehicle sensors 16 further includes a vehicle communication system 34 for receiving information from external systems. The vehicle communication system 34 is used by the controller 14 to communicate with other systems external to the vehicle 12. For example, the vehicle communication system 34 includes capabilities for communication with vehicles (“V2V” communication), infrastructure (“V2I” communication), remote systems at a remote call center (e.g., ON-STAR by GENERAL MOTORS) and/or personal devices. In general, the term vehicle-to-everything communication (“V2X” communication) refers to communication between the vehicle 12 and any remote system (e.g., vehicles, infrastructure, and/or remote systems).

In certain embodiments, the vehicle communication system 34 is a wireless communication system configured to communicate via a wireless local area network (WLAN) using IEEE 802.11 standards or by using cellular data communication (e.g., using GSMA standards, such as, for example, SGP.02, SGP.22, SGP.32, and the like). Accordingly, the vehicle communication system 34 may further include an embedded universal integrated circuit card (eUICC) configured to store at least one cellular connectivity configuration profile, for example, an embedded subscriber identity module (eSIM) profile.

The vehicle communication system 34 is further configured to communicate via a personal area network (e.g., BLUETOOTH), near-field communication (NFC), and/or any additional type of radiofrequency communication. However, additional or alternate communication methods, such as a dedicated short-range communications (DSRC) channel and/or mobile telecommunications protocols based on the 3rd Generation Partnership Project (3GPP) standards, are also considered within the scope of the present disclosure. DSRC channels refer to one-way or two-way short-range to medium-range wireless communication channels specifically designed for automotive use and a corresponding set of protocols and standards. The 3GPP refers to a partnership between several standards organizations which develop protocols and standards for mobile telecommunications. 3GPP standards are structured as “releases”. Thus, communication methods based on 3GPP release 14, 15, 16 and/or future 3GPP releases are considered within the scope of the present disclosure.

Accordingly, the vehicle communication system 34 may include one or more antennas and/or communication transceivers for receiving and/or transmitting signals, such as cooperative sensing messages (CSMs). The vehicle communication system 34 is configured to wirelessly communicate information between the vehicle 12 and another vehicle. Further, the vehicle communication system 34 is configured to wirelessly communicate information between the vehicle 12 and infrastructure or other vehicles. It should be understood that the vehicle communication system 34 may be integrated with the controller 14 (e.g., on a same circuit board with the controller 14 or otherwise a part of the controller 14) without departing from the scope of the present disclosure.

In another exemplary embodiment, the one or more vehicle sensors 16 further includes sensors to determine information about an environment within the vehicle 12. In a non-limiting example, the one or more vehicle sensors 16 further includes at least one of a seat occupancy sensor, a cabin air temperature sensor, a cabin motion detection sensor, a cabin camera, a cabin microphone, and/or the like.

It should be understood that the one or more vehicle sensors 16 discussed above are merely exemplary in nature, and that the one or more vehicle sensors 16 further may include additional and/or alternate sensors without departing from the scope of the present disclosure.

The infotainment system 18 is used to provide information to an occupant of the vehicle 12. In the scope of the present disclosure, the occupant includes a driver and/or a passenger of the vehicle 12. In an exemplary embodiment, the infotainment system 18 includes a human-machine interface (HMI) located in view of the occupant and capable of displaying text, graphics and/or images. It is to be understood that HMI display systems including LCD displays, LED displays, and the like are within the scope of the present disclosure. Further exemplary embodiments where the infotainment system 18 is disposed in a rearview mirror are also within the scope of the present disclosure.

In another exemplary embodiment, the infotainment system 18 includes a head-up display (HUD) configured to provide information to the occupant by projecting text, graphics, and/or images upon the windscreen of the vehicle 12. The text, graphics, and/or images are reflected by the windscreen of the vehicle 12 and are visible to the occupant without looking away from a roadway ahead of the vehicle 12. In another exemplary embodiment, the infotainment system 18 includes an augmented reality head-up display (AR-HUD). The AR-HUD is a type of HUD configured to augment the occupant’s vision of the roadway ahead of the vehicle 12 by overlaying text, graphics, and/or images on physical objects in the environment surrounding the vehicle 12 within a field-of-view of the occupant.

In an exemplary embodiment, the occupant may interact with the infotainment system 18 using a human-interface device (HID), including, for example, a touchscreen, an electromechanical switch, a capacitive switch, a rotary knob, and the like. It should be understood that additional systems for displaying information to the occupant of the vehicle 12 are also within the scope of the present disclosure.

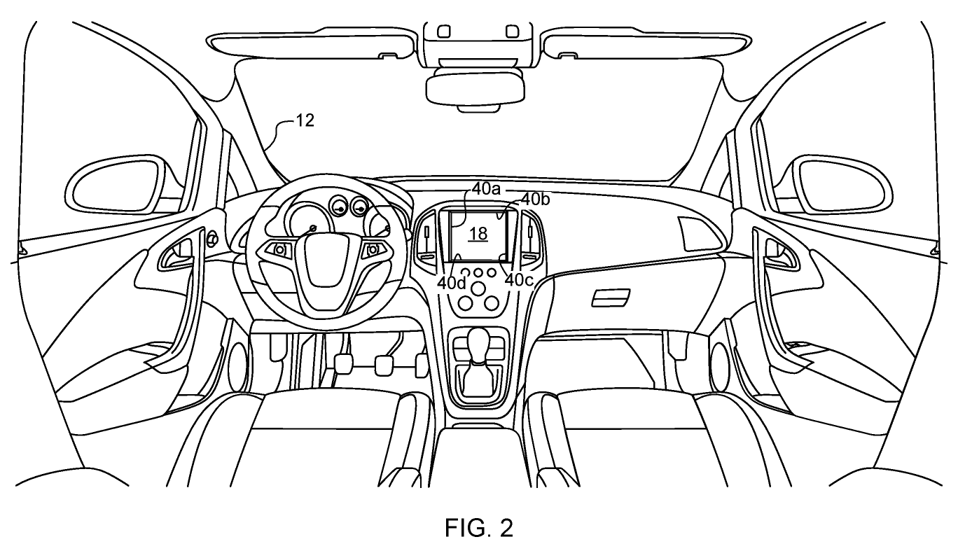

Referring to FIG. 2, a schematic diagram of an interior of the vehicle 12 including the infotainment system 18 is shown. In an exemplary embodiment, the infotainment system 18 includes a touchscreen disposed substantially centrally within a passenger compartment of the vehicle 12, for example, within a center console/dashboard of the vehicle 12, as shown in FIG. 2. In a non-limiting example, one or more edges of the infotainment system 18 are defined as edges of the touchscreen, including, for example, a left edge 40a, a top edge 40b, a right edge 40c, and a bottom edge 40d. In a non-limiting example, in a left-hand drive vehicle, the left edge 40a is closest to a driver of the vehicle 12. In a right-hand drive vehicle, the right edge 40c is closest to a passenger of the vehicle 12. It should be understood that the shape, size, location, and configuration of the infotainment system 18 shown in FIG. 2 are merely exemplary in nature.

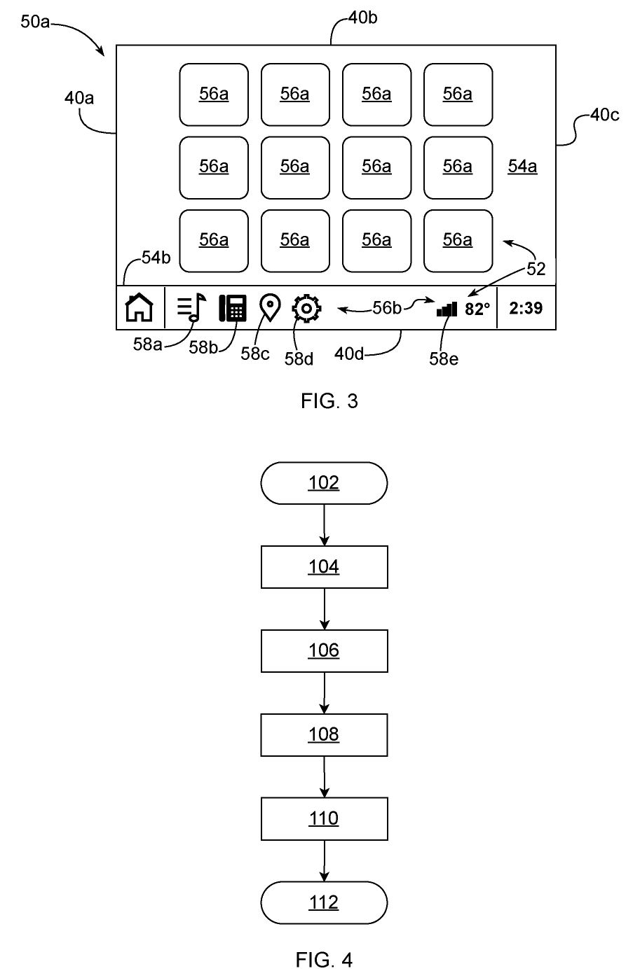

Referring to FIG. 3, a first exemplary user-interface (UI) 50a for the infotainment system 18 is shown. The first exemplary UI 50a includes a plurality of UI elements 52 within a first content area 54a and a second content area 54b. The plurality of UI elements 52 are shapes, text, images, and/or the like which are intended for interaction with the occupant of the vehicle 12 (e.g., by selecting, clicking, touching, tapping, dragging, and/or the like). The first content area 54a is used to display one or more currently running applications and/or a home screen. In FIG. 3, the home screen is displayed. In a non-limiting example, the plurality of UI elements 52 includes a plurality of application icons 56a displayed on the home screen. The plurality of application icons 56a are configured to launch various applications such as a weather information application, a mobile phone application, a navigation application, a settings application, and/or the like. When the occupant of the vehicle 12 interacts with one or more of the plurality of application icons 56a, an application may be opened and replace the home screen in the first content area 54a.

The second content area 54b is used to provide quick access to launch important applications and provide relevant information to the occupant of the vehicle 12. In an exemplary embodiment, the second content area 54b is always displayed on the screen, regardless of what application is running or displayed in the first content area 54a. In a non-limiting example, the plurality of UI elements 52 further include a plurality of control bar icons 56b displayed in the second content area 54b. In a non-limiting example, the plurality of control bar icons 56b includes a music application icon 58a, a phone application icon 58b, a navigation application icon 58c, a settings application icon 58d, and a signal-strength indication icon 58e.

In an exemplary embodiment, each of the plurality of UI elements 52 has one or more UI element characteristics. In a non-limiting example, the one or more UI element characteristics include a UI element type (e.g., button, slider, text, image, etc.), a UI element purpose (e.g., a type of application which the UI element starts, for example, a weather purpose, a phone purpose, a navigation purpose, etc.), and/or the like. The UI element purpose further may include information about an inherent importance of each of the plurality of UI elements 52. For example, a UI element for a navigation application is inherently more important to the driving task than a UI element for a music application. In a non-limiting example, the one or more UI element characteristics further include dynamic and/or statistical information about each of the plurality of UI elements 52, for example, a frequency of use or selection by the occupant.

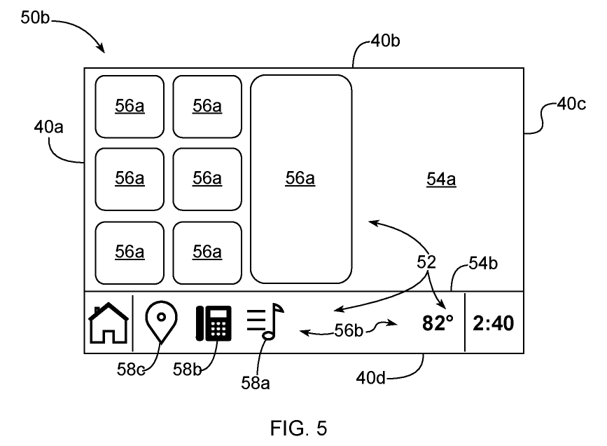

Furthermore, each of the plurality of UI elements 52 has a layout. In a non-limiting example, the layout includes a size, a shape, a rotation angle, a color, a location within the first content area 54a and/or the second content area 54b, and/or the like of each of the plurality of UI elements 52. Determination of the layout for each of the plurality of UI elements 52 will be discussed in greater detail below in reference to the method 100. It should be understood that the first exemplary user-interface (UI) 50a discussed above and shown in FIG. 3 is merely exemplary in nature, and that additional and/or alternate designs, layouts, and functionality are within the scope of the present disclosure. Furthermore, the first exemplary UI 50a shown in FIG. 3 is not necessarily to-scale, except as it relates to relative size of the plurality of UI elements 52 between FIGS. 3 and 5 discussed below.

Referring to FIG. 4, a flowchart of the method 100 for providing information to an occupant of a vehicle is shown. The method 100 begins at block 102 and proceeds to block 104. At block 104, the controller 14 determines one or more inputs. In a non-limiting example, the one or more inputs are determined using the one or more vehicle sensors 16. In an exemplary embodiment, the one or more inputs include measurements of vehicle operating conditions, such as, for example, a speed of the vehicle 12 (e.g., determined using the vehicle speed sensor 24), an acceleration of the vehicle 12 (e.g., determined using the IMU 26), a vibration of the vehicle 12 (e.g., determined using the IMU 26), a traction control system activation status of the vehicle 12 (i.e., whether the traction control system is acting to prevent slipping, which indicates slippery road conditions), a time-averaged frequency of accelerator/brake pedal actuations, and/or the like.

In an exemplary embodiment, the one or more inputs further include information about external environmental conditions, such as, for example, a weather condition in the environment 28 surrounding the vehicle 12 (e.g., determined using information received with the vehicle communication system 34 and/or the camera system 30), a traffic congestion condition and/or traffic density in the environment 28 surrounding the vehicle 12 (e.g., determined using information received with the vehicle communication system 34 and/or the camera system 30), a visibility in the environment 28 surrounding the vehicle 12 (e.g., determined using the camera system 30), a distance between the vehicle 12 and a nearest remote vehicle (e.g., determined using the LiDAR sensor 32 and/or the camera system 30), and/or the like. It should be understood that the one or more inputs discussed above are merely exemplary in nature, and that various additional and/or alternative inputs may be determined at block 104. After block 104, the method 100 proceeds to block 106.

At block 106, the controller 14 determines an importance score of each of the plurality of UI elements 52. In the scope of the present disclosure, the importance score indicates an importance of each of the plurality of UI elements 52 for the occupant of the vehicle 12. In an exemplary embodiment, the controller 14 determines the importance score of each of the plurality of UI elements 52 based at least in part on the one or more inputs determined at block 104 and the one or more UI element characteristics of each of the plurality of UI elements 52. In a non-limiting example, the importance score of each of the plurality of UI elements 52 is determined using a machine learning model trained to receive the one or more inputs and the one or more UI element characteristics of each of the plurality of UI elements 52 and provide an importance score as an output.

In another non-limiting example, the importance score of each of the plurality of UI elements 52 is determined using a deterministic algorithm. For example, the importance score is determined as a normalized weighted average of the one or more inputs determined at block 104, where the weights corresponding to each of the one or more inputs are determined based on the one or more UI element characteristics (e.g., the inherent importance). For example, the importance score of each of the plurality of UI elements 52 is positively correlated with the inherent importance of each of the plurality of UI elements 52.

In another example, the importance score of each of the plurality of UI elements 52 is positively correlated with the speed of the vehicle 12. In another example, the importance score of each of the plurality of UI elements 52 is positively correlated with the traffic density in the environment 28 surrounding the vehicle 12. In another example, the importance score of each of the plurality of UI elements 52 is negatively correlated with the distance between the vehicle 12 and the nearest remote vehicle. In another example, the importance score of each of the plurality of UI elements 52 is increased by a predetermined amount if the traction control system activation status is active.

In another example, the importance score of each of the plurality of UI elements 52 is positively correlated with the time-averaged frequency of accelerator/brake pedal actuations in the vehicle 12. It should be understood that the methods for determining the importance score discussed above are merely exemplary in nature, and that any machine learning based or non-machine learning based methods (e.g., mathematical functions, lookup tables, and/or the like) may be used without departing from the scope of the present disclosure. After block 106, the method 100 proceeds to block 108.

At block 108, the controller 14 determines the layout of each of the plurality of UI elements 52. In an exemplary embodiment, the controller 14 determines the layout of each of the plurality of UI elements 52 based at least in part on the importance score of each of the one or more UI elements determined at block 106. In an exemplary embodiment, the layout of each of the plurality of UI elements 52 is determined using a rule-based algorithm. For example, if the importance score of a UI element is greater than a first predetermined threshold, the size of the UI element is increased by a predetermined amount (e.g., ten percent) larger than a default size of the UI element. In another example, if the importance score of a UI element is greater than a second predetermined threshold, the location of the UI element is moved into a predetermined region of the infotainment system 18.

In another example, if the importance score of a UI element is less than a third predetermined threshold, the UI element is not displayed on the infotainment system 18. In another example, if the importance score of a UI element is greater than a fourth predetermined threshold, the color of the UI element is set to be a predetermined color indicating high importance (e.g., red). In another example, if the importance score of a UI element is less than a fifth predetermined threshold, the color of the UI element is set to be a predetermined color indicating low importance (e.g., gray).

In another example, the size of each of the plurality of UI elements 52 is correlated with the importance score of each of the plurality of UI elements 52. In a non-limiting example, the size of each of the plurality of UI elements 52 is positively correlated with (e.g., proportional to) the importance score of each of the plurality of UI elements 52. In another example, the location of each of the plurality of UI elements 52 is determined based on the importance score of each of the plurality of UI elements 52. In a non-limiting example, a distance between each of the plurality of UI elements 52 and an edge of the infotainment system 18 (e.g., the left edge 40a, the top edge 40b, the right edge 40c, and/or the bottom edge 40d) is negatively correlated with the importance score of each of the plurality of UI elements 52. For example, UI elements with a higher importance score are located closer to an edge nearest to the occupant (e.g., the left edge 40a in a left-hand drive vehicle or the right edge 40c in a right-hand drive vehicle).

In another non-limiting example, the location of one or more of the plurality of UI elements 52 is determined to be within one or more predefined areas of the infotainment system 18 based on comparison of the importance score of each of the plurality of UI elements 52 to one or more thresholds. For example, the one or more predefined areas may include areas which are easily reached by the occupant (e.g., areas near a seating position of the occupant and/or areas within a clear line of sight for the occupant). The one or more predefined areas may be determined based on the specific shape, size, and position of the infotainment system 18.

It should be understood that the examples of rule-based algorithms provided above are merely exemplary in nature, and that various additional and/or alternate algorithms, functions, and/or methods for determining the layout for each of the plurality of UI elements 52 are within the scope of the present disclosure. In another exemplary embodiment, the layout of each of the plurality of UI elements 52 is determined using a machine learning algorithm trained to determine a layout for each of the plurality of UI elements 52 based on the importance score of each of the plurality of UI elements 52.

Referring to FIG. 5, a second exemplary user-interface (UI) 50b for the infotainment system 18 is shown. With reference to FIGS. 3-5, the second exemplary UI 50b illustrates exemplary layout changes to the plurality of UI elements 52 as compared to the first exemplary UI 50a shown in FIG. 3. In an exemplary embodiment, as shown in the second exemplary UI 50b in comparison to the first exemplary UI 50a, some of the plurality of application icons 56a are not shown in the first content area 54a (e.g., because the importance score of some of the plurality of application icons 56a is less than the third predetermined threshold), and the remaining of the plurality of application icons 56a are shifted towards the left edge 40a and/or resized. In a non-limiting example, the remaining of the plurality of application icons 56a are shifted towards the left edge 40a to make it easier for a driver of a left-hand drive vehicle to reach the remaining of the plurality of application icons 56a. It should be understood that in a right-hand drive vehicle, the remaining of the plurality of application icons 56a may be shifted towards the right edge 40c.

In an exemplary embodiment, as shown in the second exemplary UI 50b in comparison to the first exemplary UI 50a, some of the plurality of control bar icons 56b are not shown in the second content area 54b (e.g., because the importance score of some of the plurality of control bar icons 56b is less than the third predetermined threshold), and the remaining of the plurality of control bar icons 56b are re-arranged such that icons having a higher importance score (e.g., due to a higher inherent importance) are closer to the left edge 40a. For example, the navigation application icon 58c is placed closest to the left edge 40a, followed by the phone application icon 58b and then the music application icon 58a. Furthermore, as shown in the second exemplary UI 50b in comparison to the first exemplary UI 50a, the plurality of control bar icons 56b are enlarged in size (e.g., because the importance score of each of the plurality of control bar icons 56b is greater than the first predetermined threshold).

It should be understood that the second exemplary user-interface (UI) 50b discussed above and shown in FIG. 5 is merely exemplary in nature, and that additional and/or alternate designs, layouts, and functionality are within the scope of the present disclosure. Furthermore, the second exemplary UI 50b shown in FIG. 5 is not necessarily to-scale, except as it relates to relative size of the plurality of UI elements 52 between FIGS. 3 and 5. Referring again to FIG. 4, after block 108, the method 100 proceeds to block 110.

At block 110, the controller 14 uses the infotainment system 18 to display the plurality of UI elements 52 to provide information to the occupant of the vehicle 12. In an exemplary embodiment, the controller 14 displays the plurality UI elements 52 based at least in part on the layout of each of the plurality of UI elements 52 (i.e., the size, location, color, etc.) determined at block 108. In a non-limiting example, adjustments to the layout of each of the plurality of UI elements 52 are displayed smoothly (e.g., using animations or the like) to help the occupant understand and adjust to changes in the layout of each of the plurality of UI elements 52. In another non-limiting example, the controller 14 uses hysteresis rules or algorithms to limit a frequency and/or speed of changes to the layout of each of the plurality of UI elements 52. After block 110, the method 100 proceeds to enter a standby state at block 112.

In an exemplary embodiment, the controller 14 repeatedly exits the standby state 112 and restarts the method 100 at block 102. In a non-limiting example, the controller 14 exits the standby state 112 and restarts the method 100 on a timer, for example, every three hundred milliseconds.

The system 10 and method 100 of the present disclosure offer several advantages. By adjusting the layout of UI elements based on characteristics of the vehicle state and/or characteristics of the external environment, the user-interface of the infotainment system 18 adapts to current conditions to increase occupant convenience. For example, by increasing the size of UI elements when a relatively high vibration is occurring in the vehicle 12, occupants may more easily select the UI elements and control the infotainment system 18. Furthermore, by reducing or eliminating less important UI elements in stressful driving situations (e.g., high traffic density, poor environmental conditions, etc.), the occupant may more easily control the infotainment system 18 while mitigating distractions.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for providing information to an occupant of a vehicle, the method comprising:
determining one or more inputs using one or more vehicle sensors, wherein the one or more inputs include a speed of the vehicle;
determining a layout of each of a plurality of user-interface (UI) elements of an infotainment system based at least in part on the one or more inputs, wherein determining the layout of each of the plurality of UI elements further comprises:
determining an importance score of each of the plurality of UI elements based at least in part on the one or more inputs and one or more UI element characteristics of each of the plurality of UI elements, wherein the one or more UI element characteristics include a UI element purpose of each of the plurality of UI elements, and wherein the importance score of each of the plurality of UI elements is positively correlated with the speed of the vehicle; and
determining the layout of each of the plurality of UI elements based at least in part on the importance score of each of the plurality of UI elements, wherein the layout includes at least a size of each of the plurality of UI elements and a location of each of the plurality of UI elements on the infotainment system, wherein the size of each of the plurality of UI elements is positively correlated with the importance score of each of the plurality of UI elements, wherein a distance between the location of each of the plurality of UI elements and an edge of the infotainment system nearest to the occupant is negatively correlated with the importance score of each of the plurality of UI elements, and wherein the edge of the infotainment system nearest to the occupant is a left edge of the infotainment system when the vehicle is a left-hand drive vehicle and a right edge of the infotainment system when the vehicle is a right-hand drive vehicle; and
automatically relocating and displaying each of the plurality of UI elements on the infotainment system based on the layout determined for each of the plurality of UI elements.

2. The method of claim 1, wherein determining the one or more inputs further comprises:
determining the one or more inputs, wherein the one or more inputs include measurements of vehicle operating conditions, and wherein the vehicle operating conditions include one or more of: an acceleration of the vehicle and a vibration of the vehicle.

3. The method of claim 1, wherein determining the one or more inputs further comprises:
determining the one or more inputs, wherein the one or more inputs include information about external environmental conditions.

4. The method of claim 3, wherein determining the one or more inputs further comprises:
determining the one or more inputs, wherein the information about external environmental conditions includes one or more of: a weather condition in an environment surrounding the vehicle and a traffic congestion condition in the environment surrounding the vehicle.

5. (canceled)

6. (canceled)

7. The method of claim 1, wherein the UI element purpose of each of the plurality of UI elements includes information about an inherent importance of each of the plurality of UI elements.

8. (canceled)

9. (canceled)

10. (canceled)

11. A system for providing information to an occupant of a vehicle, the system comprising:
one or more vehicle sensors;
an infotainment system; and
a controller in electrical communication with the one or more vehicle sensors and the infotainment system, wherein the controller is programmed to:
determine one or more inputs using the one or more vehicle sensors, wherein the one or more inputs include measurements of vehicle operating conditions, and wherein the vehicle operating conditions include a time-averaged frequency of accelerator pedal actuations;
determine a layout of each of a plurality of user-interface (UI) elements of the infotainment system based at least in part on an importance score of each of the plurality of UI elements, wherein the importance score is determined based at least in part on the one or more inputs and one or more UI element characteristics of each of the plurality of UI elements; and
automatically relocate and display each of the plurality of UI elements on the infotainment system based on the layout determined for each of the plurality of UI elements.

12. The system of claim 11, wherein the vehicle operating conditions further include a traction control system activation status of the vehicle.

13. The system of claim 11, wherein the one or more inputs include information about external environmental conditions, wherein the information about external environmental conditions includes one or more of: a visibility in an environment surrounding the vehicle and a distance between the vehicle and a nearest remote vehicle.

14. The system of claim 13, wherein to determine the importance score of each of the plurality of UI elements, the controller is further programmed to:
determine the importance score of each of the plurality of UI elements based at least in part on the one or more UI element characteristics of each of the plurality of UI elements, wherein the one or more UI element characteristics include a frequency of use of each of the plurality of UI elements.

15. The system of claim 14, wherein to determine the importance score of each of the plurality of UI elements, the controller is further programmed to:
determine the importance score of each of the plurality of UI elements based at least in part on a traffic congestion condition, wherein the importance score of each of the plurality of UI elements is positively correlated with a traffic density in the environment surrounding the vehicle.

16. The system of claim 15, wherein to determine the layout of each of the plurality of UI elements, the controller is further programmed to:
determine the layout of each of the plurality of UI elements based at least in part on the importance score of each of the plurality of UI elements, wherein the layout includes at least a size of each of the plurality of UI elements, and wherein the size of each of the plurality of UI elements is positively correlated with the importance score of each of the plurality of UI elements.

17. The system of claim 16, wherein to determine the layout of each of the plurality of UI elements, the controller is further programmed to:
determine the layout of each of the plurality of UI elements based at least in part on the importance score of each of the plurality of UI elements, wherein the layout includes at least a location of each of the plurality of UI elements on the infotainment system, and wherein a distance between the location of each of the plurality of UI elements and an edge of the infotainment system nearest to the occupant is negatively correlated with the importance score of each of the plurality of UI elements, and wherein the edge of the infotainment system nearest to the occupant is a left edge of the infotainment system when the vehicle is a left-hand drive vehicle and a right edge of the infotainment system when the vehicle is a right-hand drive vehicle.

18. A method for providing information to an occupant of a vehicle, the method comprising:
determining one or more inputs using one or more vehicle sensors, wherein the one or more inputs include a speed of the vehicle and one or more of: an acceleration of the vehicle, a vibration of the vehicle, a weather condition in an environment surrounding the vehicle, and a traffic congestion condition in the environment surrounding the vehicle;
determining a layout of each of a plurality of user-interface (UI) elements of an infotainment system based at least in part on an importance score of each of the plurality of UI elements, wherein the importance score is determined based at least in part on the one or more inputs, wherein the importance score of each of the plurality of UI elements is positively correlated with the speed of the vehicle, wherein the layout includes at least a size of each of the plurality of UI elements, wherein the size of each of the plurality of UI elements is positively correlated with the importance score of each of the plurality of UI elements, wherein the layout includes at least a location of each of the plurality of UI elements on the infotainment system, wherein a distance between the location of each of the plurality of UI elements and an edge of the infotainment system nearest to the occupant is negatively correlated with the importance score of each of the plurality of UI elements, wherein the edge of the infotainment system nearest to the occupant is a left edge of the infotainment system when the vehicle is a left-hand drive vehicle and a right edge of the infotainment system when the vehicle is a right-hand drive vehicle, and wherein each of the plurality of UI elements having an importance score less than a predetermined threshold is not displayed on the infotainment system; and
automatically relocating and displaying each of the plurality of UI elements having an importance score greater than the predetermined threshold on the infotainment system based on the layout determined for each of the plurality of UI elements.

19. (canceled)

20. (canceled)

21. The method of claim 1, wherein automatically relocating and displaying each of the plurality of UI elements comprises limiting, using a hysteresis rule, at least one of a frequency and a speed of changes to the layout of each of the plurality of UI elements.

22. The system of claim 11, wherein to automatically relocate and display each of the plurality of UI elements, the controller is further programmed to limit, using a hysteresis rule, at least one of a frequency and a speed of changes to the layout of each of the plurality of UI elements.

23. The method of claim 18, wherein automatically relocating and displaying each of the plurality of UI elements having an importance score greater than the predetermined threshold comprises limiting, using a hysteresis rule, at least one of a frequency and a speed of changes to the layout of each of the plurality of UI elements.
